(19) United States
(12) Patent Application Publication
(10) Pub. No.: US 2026/0336208 A1
(43) Pub. Date: Oct. 29, 2026

(54) THREE-DIMENSIONAL (3D) PRINTING OF ANISOTROPIC MATERIAL

(71) Applicant: Arizona Board of Regents on Behalf of the University of Arizona, Tucson, AZ (US)

(72) Inventor: Stanley Pau, Tucson, AZ (US)

(21) Appl. No.: 19/486,196

(22) PCT Filed: May 21, 2024
(86) PCT No.: PCT/US2024/030438

§ 371 Date: Nov. 20, 2025

Related U.S. Application Data
(60) Provisional application No. 63/503,645, filed on May 22, 2023.

(51) Int. Cl. B29C 64/209; B29C 64/135; B29C 64/268; B29C 64/393; B33Y 10/00; B33Y 30/00; B33Y 40/00

(52) U.S. Cl. CPC B29C 64/209; B29C 64/135; B29C 64/268; B29C 64/393; B33Y 10/00; B33Y 30/00; B33Y 40/00

(57) ABSTRACT

Methods and print head configurations for fabrication of complex three-dimensional (3D) structures using anisotropic materials are described. One example 3D print head includes a tubular channel configured to receive an anisotropic material, and to allow the anisotropic material to move therein, and a chamber configured to heat the anisotropic material. The 3D print head also includes one or more electrodes positioned to at least partially surround a section of the tubular channel, where the one or more electrodes are configured to receive one or more voltages to establish an electric field across the tubular channel, and the one or more voltages are selectable to allow the electric field having a magnitude and direction to be established across the tubular channel.

### CROSS-REFERENCE TO RELATED APPLICATION(S)

This application claims priority to the provisional application with Ser. No. 63/503,645 titled “THREE-DIMENSIONAL (3D) PRINTING OF ANISOTROPIC MATERIAL,” filed May 22, 2023. The entire contents of the above noted provisional application are incorporated by reference as part of the disclosure of this document.

### TECHNICAL FIELD

This description in this patent document relates three dimensional printing devices and methods.

### BACKGROUND

Traditional applications of three dimensional (3D) printing include industrial manufacturing, prototypes, art and optics. Other applications include surgical or dental prosthetics, human organs, biomedical implants, fashion, food, pharmaceuticals, construction and architecture, tissue engineering to name a few. 3D printing or additive manufacturing have multiple advantages such as design flexibility to create complex shapes and geometries, rapid prototyping and testing, produce strong and lightweight components, production on demand and low waste. Disadvantages include limited materials, rough surfaces which require post processing, high initial and maintenance cost of the printer, lack of control in material anisotropy, restricted build size limited by the printer, and, in some cases, inability to create homogenous parts which do not scatter or separate. It is therefore beneficial to improve the 3D printing process to improve the quality of the printed objects, to enable printing of anisotropic material with expanded applications and utilities.

### SUMMARY

The disclosed technology relates to methods and print head configurations for fabrication of complex 3D structures using anisotropic materials. The described techniques control both the shape and alignment of the anisotropic materials using applied electric and/or magnetic fields and/or polarized light. The magnitude and direction of the applied fields can be changed to create different anisotropic alignment during the fabrication process by adjusting the voltages of the multiple electrodes and/or the currents in the multiple solenoid coils. A complex 3D object with spatially varying anisotropy can be constructed layer by layer using different materials. Example materials can have anisotropic mechanical, optical, electrical, magnetic, thermal, piezoelectric, thermoelectric, pyroelectric, ferroelectric and chemical properties. Examples of common materials include thermoplastics, thermosetting plastics, liquid crystal polymers, resin, metal and composites (carbon fiber, Kevlar, fiberglass, with dopant such as dyes and photoluminescent molecules).

One example 3D print head includes a tubular channel configured to receive an anisotropic material, and to allow the anisotropic material to move therein, and a chamber configured to heat the anisotropic material. The 3D print head also includes one or more electrodes positioned to at least partially surround a section of the tubular channel, where the one or more electrodes are configured to receive one or more voltages to establish an electric field across the tubular channel, and the one or more voltages are selectable to allow the electric field having a magnitude and direction to be established across the tubular channel.

### BRIEF DESCRIPTION OF THE DRAWINGS

FIG. 1 illustrates a cross-sectional depiction of an example print head of a fused deposition modeling (FDM) three-dimensional (3D) printing system.

FIG. 2 illustrates an example 3D printing process for creating an object.

FIG. 3 illustrates a cross-sectional depiction of a 3D print head in accordance with and example embodiment.

FIG. 4 illustrates three electrode configurations that can be used in a 3D print head in accordance with example embodiments.

FIG. 5A illustrates a cross-sectional diagram of an electrode configuration and associated electric fields in accordance with example embodiments.

FIG. 5B illustrates a cross-sectional diagrams of electrode configurations with non-circular tubes in accordance with example embodiments.

FIG. 6 illustrates two cross-sectional diagrams of ring electrode configurations in accordance with example embodiments.

FIG. 7 illustrates three solenoid configurations in accordance with example embodiments.

FIG. 8 illustrates a cross-sectional diagram of stereolithography (SLA) 3D printing system in accordance with an example embodiment.

FIG. 9 illustrates a set of operation that can be carried out to produce a 3D object comprising anisotropic material with one or more specific alignments in accordance with an example embodiment.

FIG. 10 illustrates a set of operation that can be carried out to produce a three-dimensional object comprising anisotropic material with one or more specific alignments using a stereolithographic system in accordance with an example embodiment.

### DETAILED DESCRIPTION

It is beneficial to have the capability of producing 3D-printed objects, or parts thereof, that exhibit directional anisotropy, and developing methods and devices that allow such material with spatially varying anisotropy directions to be easily produced. Controlling the anisotropy direction can allow the 3D-printed material to exhibit preferential heat conduction, electrical conductions, light conduction, and/or allow the printed material to be easily bent in a particular direction or preferentially manipulated in a desired manner.

Main techniques of 3D printing are fused deposition modeling (FDM), stereolithography (SLA), and selective laser sintering (SLS). FDM utilizes a print head to melt and extrude filaments to create a layer-by-layer structure on a platform. SLA utilizes scanning laser(s) to cure thermosetting liquid resins into hardened plastic. SLS utilizes high a powered laser to fuse powdered material to create a solid structure. The disclosed embodiments can utilize FDM which can use liquid, powder and/or solid filament and SLA which uses photosensitive liquid.

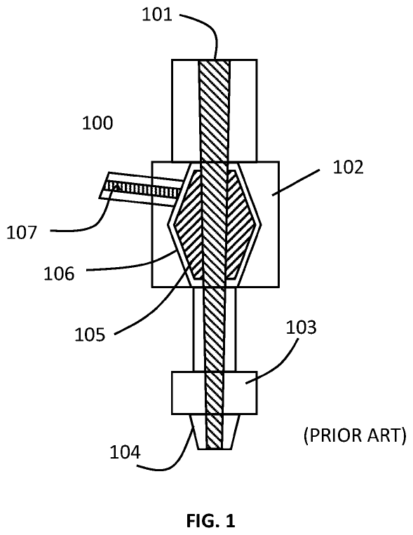

FIG. 1 illustrates a cross-sectional depiction of a print head 100 for FDM. Material is injected into a tube area 101 which leads to an optical cavity chamber 105 made of quartz. Laser light is injected into the chamber 105 through an opening 107 and is reflected by mirror coating 106 to heat the material to a predefined temperature. The heated tube 101 operates as a tapered liquefier. The optical cavity is enclosed by a metal heat sink 102. The heated material is injected into a heater block 103 and to a nozzle 104. Material is cooled and solidified after extrusion from the nozzle. In some configurations, the optical cavity is replaced by a heating chamber connected to electric heater.

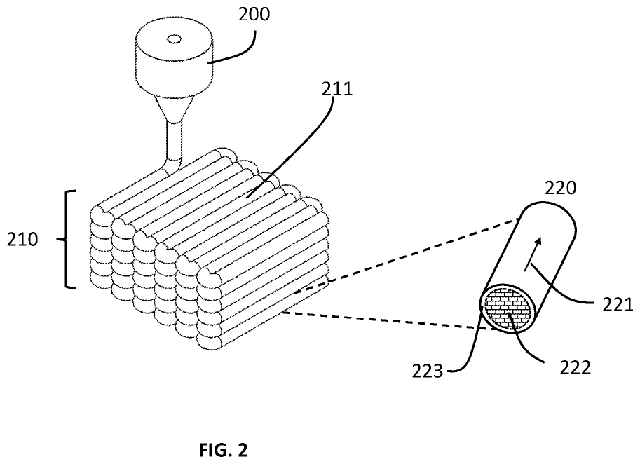

FIG. 2 illustrates an example 3D printing process for creating an object. A 3D printed component 210 with complex geometry can be created layer-by-layer as the print head 200 moves and extrudes materials. Each layer 211 can consist of tubular material 220 in a serpentine shaped path. In a 3D printer, the print head can be mounted on a programmable precision stage. Alternatively, the print head's location can be fixed, and the platform can be moved during the 3D printing process. Important printing parameters include material flow rate, temperature, print velocity and acceleration; in general, each parameter must be optimized for different materials and designs. The basic element of the 3D printed component is the tube 220. The dimensions of the tube determine the print resolution and is controlled by the nozzle size, print velocity and acceleration. The tube 220 has a homogeneous core region 222 and a thin shell region 223. The disclosed embodiments, among other features and benefits, provide a method and apparatus to control the anisotropic material properties of the core region. The anisotropy is defined by a direction 221. For materials such as liquid crystal polymer, the direction 221 can be set to be equal to the molecular axis of the liquid crystal molecule.

The orientation of the liquid crystal molecule can be changed by application of an external field. Molecules with an electric and/or magnetic dipole moment experience a torque in a uniform electric and/or magnetic field that is proportional to the magnitude of the applied field. The torque can be used to change and align the molecular axis of the molecule. The same molecule also experiences a force in a non-uniform electric and/or magnetic field.

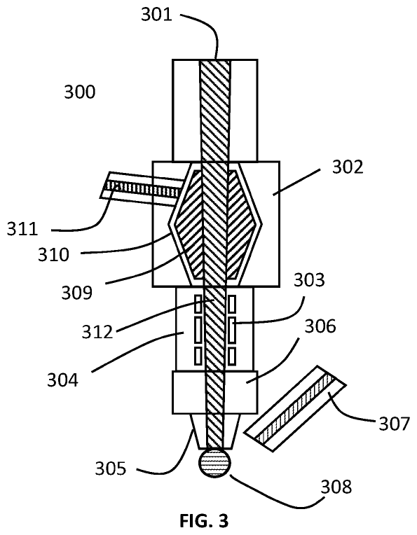

FIG. 3 illustrates a cross-sectional depiction of a 3D print head in accordance with and example embodiment. The print head 300 includes a tube 301, and material is injected into the tube 301 area leading to an optical cavity chamber 309, which can be made of, for example, quartz. Laser light is injected into the chamber through an opening 311. The interior walls of the chamber include reflective material (e.g., a reflective coating 310) to allow light that enters the chamber and the portions thereof that is not immediately absorbed by the anisotropic material to be reflected by mirror coating 310 to heat the material to a predefined temperature. The heated tube 301 operates as a tapered liquefier. The optical cavity is enclosed by a metal heat sink 302. The heated material is injected into an alignment chamber 312, surrounded by electrodes 303 and heater block 304. Material is aligned and injected to another heater block 306 and subsequently to a nozzle 305. The aligned material 308 is cooled after extrusion from the nozzle and is cured by ultraviolet light from a waveguide 307. The material 308 is solidified after the curing processing. In some embodiments, the optical cavity is replaced by a heating chamber connected to an electric heater. In other embodiments, the electrodes 303 are replaced by solenoids. In yet another embodiment, both electrodes and solenoids are used in the alignment chamber 312. The orientation of the material can in principle be changed by mechanical rotation of the print head during the printing process, but such rotation can change the shape and create unwanted stress in the final structure.

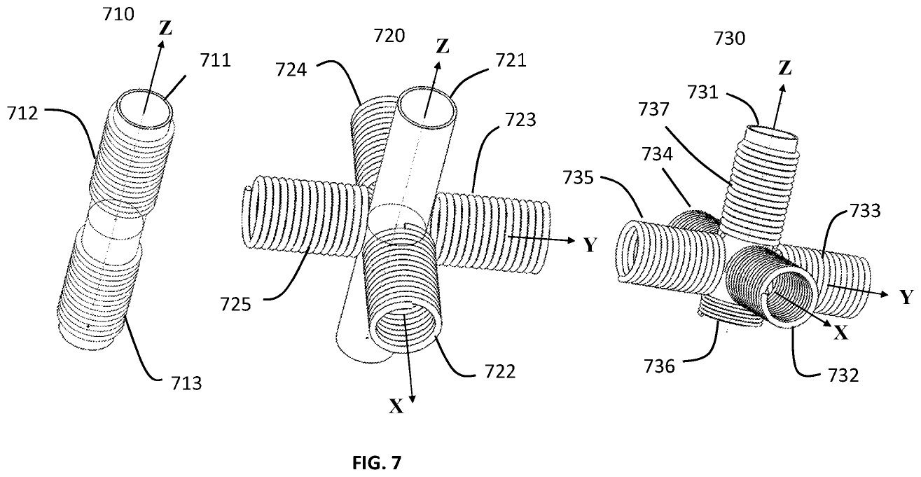

It should be noted that while the configuration of FIG. 3 illustrates an alignment chamber 312 that is positioned immediately after the optical cavity chamber 309, in some embodiments the alignment chamber and the optical cavity chamber be combined or form a single section of the 3D printing head. For example, the optical cavity chamber may include electrodes that operate to also impart a particular alignment to the anisotropic material. This can form an alternate embodiment, in which the need for a separate alignment chamber is eliminated. In some embodiments, the print head can include the alignment mechanism that is incorporated into the optical cavity as well as the alignment chamber 312 to, for example, enable incorporation of inductive alignment means (see, e.g., FIG. 7 and associated description) at one of the locations.

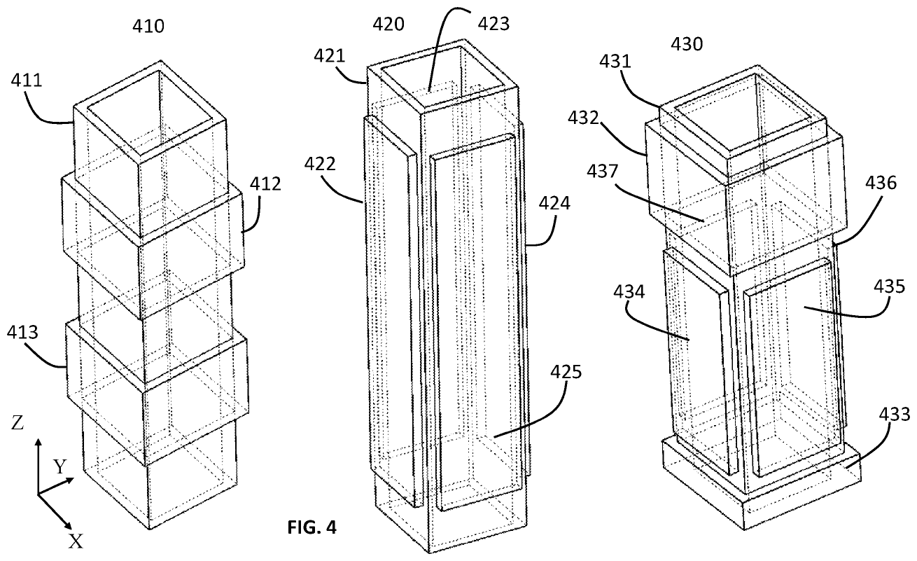

Molecules can be aligned using an electric field generated by multiple electrodes. FIG. 4 shows three electrode configurations 410, 420 and 430 in accordance with three example embodiments. In 410, a tube 411 has two ring electrodes 412 and 413. The ring electrodes form a closed circumference around the tube 411. In 420, a tube 421 has four plate electrodes 422, 423, 424, and 425. In 430, a tube 431 has two ring electrodes 432 and 433 and four plate electrodes 434, 435, 436, and 437. In other embodiments, the number of electrodes can range from two to larger than six. The desired electric field distribution inside the tube determines the number and shape of the electrodes.

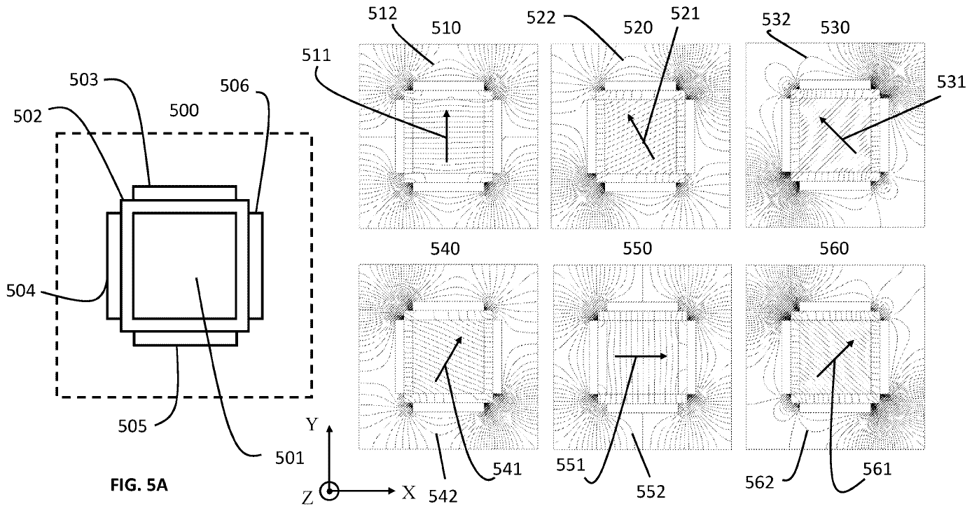

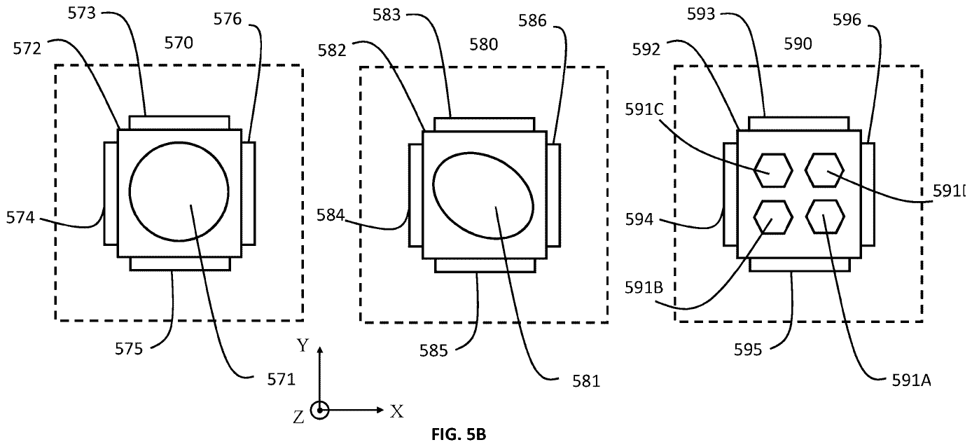

The electric field between two parallel plate electrodes is given by E=V/d, where V and d are the voltage and distance between plates, respectively. Typical field strength to align a liquid crystal molecule can range from 10⁵ to 10⁷ V/m. The electric field magnitude and direction can be tuned by changing the relative voltage of the electrodes. A cross-sectional diagram 500 of the electrode configuration 420 is shown on the left-hand side of FIG. 5A. As shown in the left side of FIG. 5A, a tube 502 with interior region 501 is surrounded by four electrodes 503, 504, 505 and 506. Each of the six cross-sectional diagrams 510, 520, 530, 540, 550 and 560 shows the equal potential contour inside the tube under a different voltage that is applied to the electrode. The examples of equal potential lines under different applied voltages are identified as 512, 522, 532, 542, 552, and 562. In these examples, the direction of the electric field is perpendicular to the equal potential lines. The examples of the direction of the electric field are identified as 511, 521, 531, 541, 551 and 561.

In the example configuration 510, the voltages for the top electrode 503, the bottom electrode 505, the left electrode 504 and the right electrode 506 are +1V, −1V, 0V and 0V, respectively. In the example configuration 520, the voltages for the top electrode 503, the bottom electrode 505, the left electrode 504 and the right electrode 506 are +1V, −1V, +0.5V and −0.5V, respectively. In the example configuration 530, the voltages for the top electrode 503, the bottom electrode 505, the left electrode 504 and the right electrode 506 are +1V, −1V, +1V and −1V, respectively. In the example configuration 540, the voltages for the top electrode 503, the bottom electrode 505, the left electrode 504 and the right electrode 506 are +1V, −1V, −0.5V and +0.5V, respectively. In the example configuration 550, the voltages for the top electrode 503, the bottom electrode 505, the left electrode 504 and the right electrode 506 are 0V, 0V, −1V and +1V, respectively. In the example configuration 560, the voltages for the top electrode 503, the bottom electrode 505, the left electrode 504 and the right electrode 506 are +1V, −1V, −1V and +1V, respectively.

As seen from the equal potential contour lines, the magnitude of the electric field inside the tube region 501 is substantially uniform, and the direction of the electric field in the X-Y plane can be tuned by adjusting the relative voltages of the electrodes 503, 504, 505 and 506. The voltage applied to each electrode can be programmed to control the orientation direction of the material inside the alignment chamber 312. This direction can be different from and is related to the orientation direction 221 of the 3D printed tube 220 shown in FIG. 2. The exact relationship of the two directions is determined by an initial calibration process which maps electrode voltages to the final 3D printed direction 221. In the above example, the maximum and minimum voltages were +1V and −1V, respectively. The exact voltage range for a design is determined by the electrode configuration, tube geometry and required electric field for the alignment process.

The cross-section shape of the tube 501 is not limited to a rectangle, and can include other shapes such as a circle, ellipse, polygon, parallelogram, trapezoid, or a combination thereof. Arbitrary shapes can be used depending on the requirement on the shape of the extruded material. A cross-sectional diagram 570 of an example electrode configuration with a circular tube is shown in the left panel of FIG. 5B. A tube 572 with interior region 571 is surrounded by four electrodes 573, 574, 575 and 576. In another design, a cross-sectional diagram 580 of an example electrode configuration with rotated elliptical tube is shown in the middle panel of FIG. 5B. A tube 582 with interior region 581 is surrounded by four electrodes 583, 584, 585 and 586. In yet another design, a cross-sectional diagram 590 of an example electrode configuration with four hexagonal tubes is shown in the right panel of FIG. 5B. A tube enclosure 592, with interior regions 591A, 591B, 591C and 591D, is surrounded by four electrodes 593, 594, 595 and 596. Four interior regions to extrude materials can potentially increase the speed of the 3D printing process. In the example configuration 590, the electric field in the four interior regions are controlled by four shared electrodes 593, 594, 595 and 596. In other configurations (not shown), each interior region can have its own set of electrodes, such that each interior region can have different electric fields that are controlled independently.

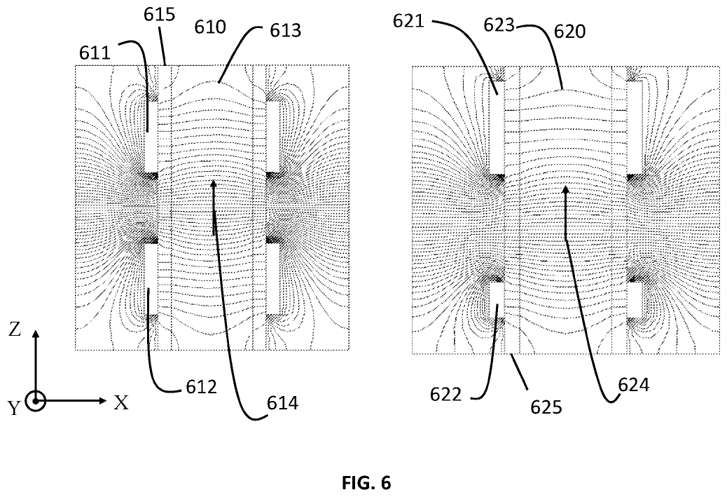

FIG. 6 shows two cross-sectional diagrams, 610 and 620, of two example ring electrode configurations (based on the configuration 410 in FIG. 4). In one configuration (left panel), a tube 615 is surrounded by two ring electrodes 611 and 612 of equal size. A positive voltage is applied to the top ring electrode 611, and a negative voltage is applied to the bottom ring electrode 612. The cross-section diagram 610 shows the equal potential contour 613 inside the tube. A uniform electric field 614 in the Z direction is created inside the tube. In another configuration (right panel), a tube 625 is surrounded by two ring electrodes 621 and 622 with differing sizes. A positive voltage is applied to the top ring electrode 621, and a negative voltage is applied to the bottom ring electrode 622. The cross-section diagram 620 shows the equal potential contour 623 inside the tube. A uniform electric field 624 in the Z direction is created inside the tube.

The configuration that uses two electrodes (based on, e.g., the configuration 410 in FIG. 4) can be utilized to generate different magnitudes of electric field inside the tube along the Z direction. A configuration with four electrodes (based on, e.g., the configuration 420 in FIG. 4) can be utilized to generate different magnitudes of electric field inside the tube along the X and Y directions. By the superposition principle, the configuration of six electrodes (based on, e.g., the configuration 430 in FIG. 4) can be utilized to generate different magnitudes of electric field inside the tube along the X, Y and Z directions.

The magnetic field along the axis a solenoid is given by B=μ₀nI, where μ₀=4π×10⁻⁷Tm/A is the permeability of free space, n is number of turns per unit length and I is the current. Typical field strength to align a liquid crystal molecule can range from 10⁻¹ to 10⁻³T. The magnetic field magnitude and direction can be tuned by changing the relative current inside the solenoid. Three configurations 710, 720 and 730 of solenoids are shown in FIG. 7. In configuration 710 (left panel), a top solenoid 712 and a bottom solenoid 713 are used to generate a uniform magnetic field along the Z direction inside the tube 711. In configuration 720 (middle panel), four solenoids 722, 723, 724 and 725 are used to generate a uniform magnetic field along the X and Y directions inside the tube 721. In configuration 730 (right panel), six solenoids 732, 733, 734, 735, 736 and 737 are used to generate a uniform magnetic field along the X, Y and Z directions inside the tube 731. The cross-sectional shapes of the tube and the solenoids are not limited to circles and rectangles and can include other shapes such as an ellipse, polygon, parallelogram, trapezoid, or a combination thereof. The solenoids can be permanent magnet solenoids made of bar magnets surrounded by coils. The currents flowing to each solenoid can be programmed to control the orientation direction of the material inside the alignment chamber 312. This direction can be different from and is related to the orientation direction 221 of the 3D printed tube 220 shown in FIG. 2. The exact relationship of the two directions is determined by initial calibration process which maps solenoid currents to the final 3D printed direction 221.

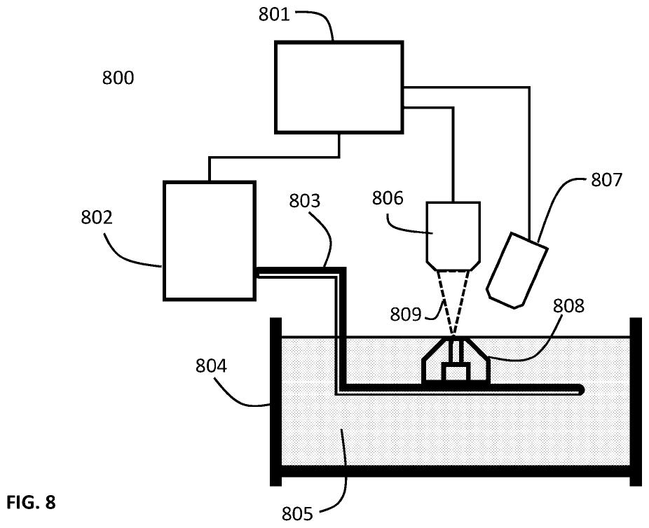

A cross-sectional depiction of an example SLA system 800 is shown in FIG. 8. The system is controlled by a controller or computer 801 connected to a precision mechanical stage 802 and a build platform 803. A laser scanner 806 is used to irradiate photosensitive liquid 805 inside a reservoir container 804. The scanner 806 which can also be controlled by the computer 801 can output laser light 809 of different intensities, directions, locations and/or polarization states. In one embodiment, the scanner 806 outputs light of a single wavelength and the liquid 805 includes a mixture of a photoalignment material and a liquid crystal polymer material. Both the photoalignment and liquid crystal polymer materials are designed to be photosensitive to the wavelength of the laser.

In another example embodiment, the scanner 806 outputs light of two wavelengths. The computer 801 controls the intensity, direction, location and/or polarization state of the output light at the two wavelengths independently. The photoalignment material is sensitive to laser light of one wavelength, and the liquid crystal polymer is sensitive to laser light of the other wavelength. In another example embodiment, the scanner 806 outputs light of three wavelengths. The computer 801 controls the intensity, direction, location and polarization state of the output light at the three wavelengths independently. The photoalignment material is sensitive to laser light of one wavelength, and the liquid crystal polymer is sensitive to laser light of the other wavelength. For example, the third wavelength of light is infrared and is used to locally heat up the material to a pre-defined temperature.

In other example embodiments, a coating sprayer 807 is used to deposit photoalignment material on the 3D printed surface during the 3D printing process. In another example embodiment, the laser scanner 806 is connected to a precision programmable stage (not shown). In some embodiments, a light source with programmable polarization states can be used to generate different polarization states. As an example, a linear polarized light source of tunable polarization orientation can be constructed by using a laser that outputs linear polarized light in combination with a tunable or rotating waveplate.

A 3D object 808 is created layer-by-layer using the SLA system 800 by the following 3D printing process. Each layer is comprised of a photoalignment layer having a photoalignment material and a structural layer having a liquid crystal polymer. The laser scanner 806 outputs focused laser light 809 onto the liquid photoalignment material. The photoalignment material can be inside the reservoir 805 or deposited by a coater 807. The spatial orientation of the photoalignment layer is determined by the polarization state of the output laser. After exposure, the photoalignment layer is solidified into a layer with spatially varying anisotropy direction. The build platform 803 is moved downward in the vertical direction. A second layer made of liquid crystal polymer is exposed a second time by the laser scanner 806. The liquid crystal material can be inside the reservoir 805 or deposited by a coater 807. After exposure, the liquid crystal polymer layer is solidified into a layer with spatially varying anisotropy direction identical to the photoalignment layer. The anisotropy direction of the liquid crystal layer is determined based on the polarization state of the light that is used to expose the photoalignment layer. Generally, due the differing materials of the layer, the polarization of the light illuminating the photoalignment layer and the liquid crystal polymer are not identical even if the same anisotropy direction is desired. In some example embodiments, the direction of the liquid crystal polymer layer is not identical to and is offset by a finite angle relative to the photoalignment layer. In the 3D printing process, each layer of the object 808 has at least two exposures, one to create the pattern and alignment of the photoalignment layer and one to create the pattern of the liquid crystal polymer layer. Example of photoalignment process using photoalignment layer and different liquid crystal polymers is described in U.S. Pat. Nos. 8,866,997 and 9,671,538 that are incorporated by reference herein. The thickness of the photoalignment layer can range from 0.05 to 1 micron. The thickness of the liquid crystal polymer layer can range from 0.1 to 10 microns, and in some embodiments to 100 microns.

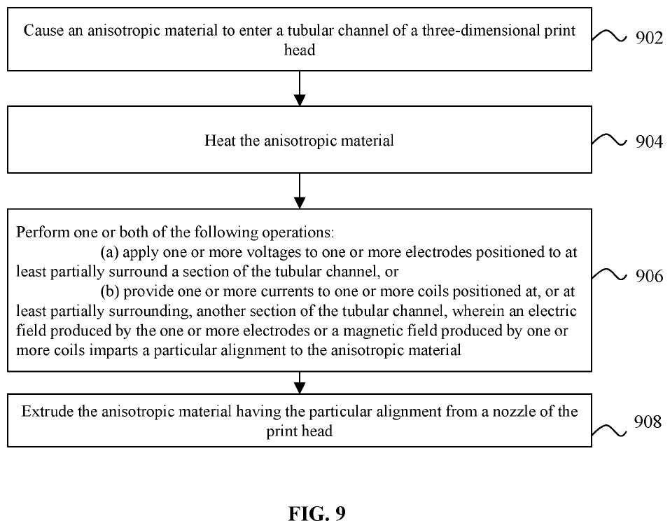

FIG. 9 illustrates a set of operation that can be carried out to produce a three-dimensional object comprising anisotropic material with one or more specific alignments in accordance with an example embodiment. At 902, an anisotropic material is caused to enter a tubular channel of a three-dimensional print head. At 904, the anisotropic material is heated. At 906, one or both of the following operations are performed: (a) applying one or more voltages to one or more electrodes positioned to at least partially surround a section of the tubular channel, or (b) providing one or more currents to one or more coils positioned at, or at least partially surrounding, another section of the tubular channel, wherein an electric field produced by the one or more electrodes or a magnetic field produced by one or more coils imparts a particular alignment to the anisotropic material. At 908, the anisotropic material having the particular alignment is extruded from a nozzle of the print head.

In one example embodiment, the above method further includes modifying one or both of: (a) the one or more voltages or (b) the one or more currents to impart a different alignment to the anisotropic material. In another example embodiment, the modifying is carried out to produce a different alignment for each layer of the three-dimensional object. In still another example embodiment, the modifying is carried out to produce a first alignment for one part of a first layer of the three-dimensional object that is different from a second alignment for another part of the first layer of the three-dimensional object.

Another aspect of the disclosed embodiments relates to a three-dimensional print head that includes a tubular channel configured to receive an anisotropic material, and to allow the anisotropic material to move therein, a chamber configured to heat the anisotropic material, and one or more electrodes positioned to at least partially surround a section of the tubular channel. The one or more electrodes are configured to receive one or more voltages to establish an electric field across the tubular channel and the one or more voltages are selectable to allow the electric field having a magnitude and direction to be established across the tubular channel.

In one example embodiment, the tubular channel comprises an alignment chamber and the one or more electrodes are positioned to at least partially surround the alignment chamber. In another example embodiment, the 3D print head includes a heater block configured to apply heat to the anisotropic material within the alignment chamber. In still another example embodiment, the one or more electrodes include a plurality of flat electrodes. In yet another example embodiment, all electrodes of the plurality of flat electrodes have the same size. In another example embodiment, the plurality of flat electrodes includes two or more sets of flat electrodes, wherein each set of the flat electrodes is positioned to at least partially surround a different section of the tubular chamber compared to another set of the flat electrodes. In one example embodiment, a first set of the flat electrodes has electrodes that differ in size from electrodes in a second set of flat electrodes.

According to another example embodiment, the one or more electrodes includes one or more ring electrodes. In one example embodiment, the one or more electrodes includes at least two ring electrodes, and each ring electrode is positioned to surround a different section of the tubular channel. In still another example embodiment, the one or more electrodes includes at least one ring electrode and one set of flat electrodes. In yet another example embodiment, the tubular channel is configured to include one or more of a rectangular, circular, elliptical or a polygonal cross section to allow extrusion of the anisotropic material with one or more of rectangular, circular, elliptical or polygonal cross-sectional geometries. In another example embodiment, the tubular channel is configured to include a plurality of channels that allow the anisotropic material to move therethrough. In one example embodiment, the one or more electrodes comprises a plurality of electrodes that allow establishing different electric fields for each of the plurality of channels.

In some example embodiments, the one or more voltages include different voltage values that are applied to different electrodes. In one example embodiment, the one or more voltages include a first voltage value or values that allow tuning or selection of a component of the electric field in a longitudinal direction, and a second voltage value or values that allow tuning or selection of one or more components of the electric field in one or more transverse directions. In another example embodiment, the electric field is configured to impart a particular alignment to the anisotropic material. In yet another example embodiment, the 3D print head includes a nozzle configured to allow the anisotropic material to be extruded from the print head, and a conduit to allow ultraviolet light to illuminate and cure the extruded anisotropic material. In still another example embodiment, the chamber is configured to receive laser light to enable heating of the anisotropic material within the chamber. In another example embodiment, the 3D print head further includes one or more coils positioned at, or at least partially surrounding a part of the tubular channel to establish a magnetic field for alignment of the anisotropic material. For example, the one or more coils are positioned along, any one or a combination of, a longitudinal axis of the tubular channel, or one or more transverse axes of the tubular channel.

Another aspect of the disclosed embodiments relates to a three-dimensional print head that includes a tubular channel configured to receive an anisotropic material, and to allow the anisotropic material to move therein. The 3D print hear also includes a chamber configured to heat the anisotropic material, and one or more coils positioned at, or at least partially surrounding, a section of the tubular channel, the one or more coils configured to receive one or more currents to establish a magnetic field across the tubular channel. The one or more currents are selectable to allow the magnetic field having a magnitude and direction to be established across the tubular channel.

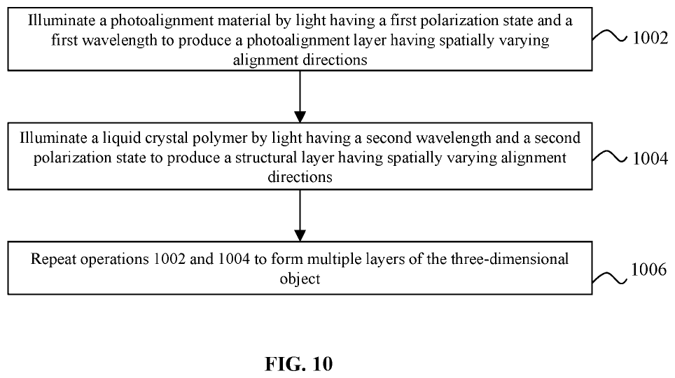

FIG. 10 illustrates a set of operation that can be carried out to produce a three-dimensional object comprising anisotropic material with one or more specific alignments using a stereolithographic system in accordance with an example embodiment. At 1002, a photoalignment material is illuminated by light having a first polarization state and a first wavelength to produce a photoalignment layer having spatially varying alignment directions. At 1004, a liquid crystal polymer is illuminated by light having a second wavelength and a second polarization state to produce a structural layer having spatially varying alignment directions. At 1006, operations 1002 and 1004 are repeated to form multiple layers of the three-dimensional object.

In one example embodiment, the photoalignment layer and the structural layer have different spatially varying anisotropy directions. In another example embodiment, an anisotropy direction of the structural layer is offset by a finite angle relative to an anisotropy direction of the photoalignment layer. In yet another example embodiment, prior to the illuminating in operation 1002, a sprayer is used to deposit the photoalignment layer material onto a plane of the three-dimensional object that is positioned on a moveable stage, and prior to the illuminating in operation 1004, a sprayer is used to deposit the crystal polymer material onto another plane of the three-dimensional object that is positioned on the moveable stage. In still another example embodiment, one or both of the photoalignment material or the liquid crystal polymer are in the reservoir as a liquid, and one or both of the photoalignment layer or the structural layer is produced by illuminating the liquid by the light having the first or the second wavelengths or polarization states.

Another aspect of the disclosed embodiments relates to a stereolithography (SLA) three-dimensional printing system that includes a controller, a movable mechanical stage coupled to the controller and operable to move at least in a vertical direction, a laser scanner operable to output one or more scannable laser beams in at least a plane that is transverse to the vertical direction, and one or both of (a) reservoir or (b) a sprayer. The SLA three-dimensional printing system is operable to: produce a three-dimensional object on a layer-by-layer basis, each layer having a photoalignment layer and a structural layer comprising a liquid crystal polymer, produce the photoalignment layer having a particular alignment through illumination of photoalignment material of the photoalignment layer by light having a first polarization state and a first wavelength, and produce the structural layer through illumination of the liquid crystal polymer by light having a second wavelength and a second polarization state.

In one example embodiment, one or both of the photoalignment layer or the structural layer have spatially varying anisotropy directions. In another example embodiment, the photoalignment layer and the structural layer have different spatially varying anisotropy directions. In yet another example embodiment, an anisotropy direction of the structural layer is offset by a finite angle relative to an anisotropy direction of the photoalignment layer. In still another example embodiment, prior to illumination, material of each of the photoalignment layer and the structural layer is deposited onto a plane of the three-dimensional object that is positioned on the moveable stage using the sprayer. In another example embodiment, one or both of the photoalignment material or the liquid crystal polymer are in the reservoir as a liquid, and one or both of the photoalignment layer or the structural layer is produced through illumination of the liquid by the light having the first or the second wavelengths or polarization states.

Various operations disclosed herein can be implemented using a processor/controller is configured to include, or be coupled to, a memory that stores processor executable code that causes the processor/controller carry out various computations and processing of information. The processor/controller can further generate and transmit/receive suitable information to/from the various system components, as well as suitable input/output (IO) capabilities (e.g., wired or wireless) to transmit and receive commands and/or data. The processor/controller may, for example, provide signals to apply voltages and currents to the electrodes and coils that are described herein, or to selectively activate or deactivate various components or operations.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Only a few implementations and examples are described and other implementations, enhancements and variations can be made based on what is described and illustrated in this patent document.

1. A three-dimensional print head, comprising:
a tubular channel configured to receive an anisotropic material, and to allow the anisotropic material to move therein;
a chamber configured to heat the anisotropic material; and
one or more electrodes positioned to at least partially surround a section of the tubular channel, the one or more electrodes configured to receive one or more voltages to establish an electric field across the tubular channel, wherein
the one or more voltages are selectable to allow the electric field having a magnitude and direction to be established across the tubular channel.

2. The three-dimensional print head of claim 1, wherein:
the tubular channel comprises an alignment chamber and the one or more electrodes are positioned to at least partially surround the alignment chamber.

3. The three-dimensional print head of claim 2, including a heater block configured to apply heat to the anisotropic material within the alignment chamber.

4. The three-dimensional print head of claim 1, wherein the one or more electrodes include a plurality of flat electrodes.

5. The three-dimensional print head of claim 4, wherein all electrodes of the plurality of flat electrodes have the same size.

6. The three-dimensional print head of claim 4, wherein the plurality of flat electrodes includes two or more sets of flat electrodes, wherein each set of the flat electrodes is positioned to at least partially surround a different section of the tubular chamber compared to another set of the flat electrodes.

7. The three-dimensional print head of claim 6, wherein a first set of the flat electrodes has electrodes that differ in size from electrodes in a second set of flat electrodes.

8. The three-dimensional print head of claim 1, wherein the one or more electrodes includes one or more ring electrodes.

9. The three-dimensional print head of claim 8, wherein the one or more electrodes includes at least two ring electrodes, and wherein each ring electrode is positioned to surround a different section of the tubular channel.

10. The three-dimensional print head of claim 1, wherein the one or more electrodes includes at least one ring electrode and one set of flat electrodes.

11. The three-dimensional print head of claim 1, wherein the tubular channel is configured to include one or more of a rectangular, circular, elliptical or a polygonal cross section to allow extrusion of the anisotropic material with one or more of rectangular, circular, elliptical or polygonal cross-sectional geometries.

12. The three-dimensional print head of claim 1, wherein the tubular channel is configured to include a plurality of channels that allow the anisotropic material to move therethrough.

13. The three-dimensional print head of claim 12, wherein the one or more electrodes comprises a plurality of electrodes that allow establishing different electric fields for each of the plurality of channels.

14. The three-dimensional print head of claim 1, wherein the one or more voltages include different voltage values that are applied to different electrodes.

15. The three-dimensional print head of claim 1, wherein the one or more voltages include a first voltage value or values that allow tuning or selection of a component of the electric field in a longitudinal direction, and a second voltage value or values that allow tuning or selection of one or more components of the electric field in one or more transverse directions.

16. The three-dimensional print head of claim 1, wherein the electric field is configured to impart a particular alignment to the anisotropic material.

17. The three-dimensional print head of claim 1, comprising a nozzle configured to allow the anisotropic material to be extruded from the print head, and a conduit to allow ultraviolet light to illuminate and cure the extruded anisotropic material.

18. The three-dimensional print head of claim 1, wherein the chamber is configured to receive laser light to enable heating of the anisotropic material within the chamber.

19. The three-dimensional print head of claim 1, further including one or more coils positioned at, or at least partially surrounding a part of the tubular channel to establish a magnetic field for alignment of the anisotropic material.

20. The three-dimensional print head of claim 17, wherein the one or more coils are positioned along, any one or a combination of, a longitudinal axis of the tubular channel, or one or more transverse axes of the tubular channel.

21. A three-dimensional print head, comprising:
a tubular channel configured to receive an anisotropic material, and to allow the anisotropic material to move therein;
a chamber configured to heat the anisotropic material; and
one or more coils positioned at, or at least partially surrounding, a section of the tubular channel, the one or more coils configured to receive one or more currents to establish a magnetic field across the tubular channel, wherein
the one or more currents are selectable to allow the magnetic field having a magnitude and direction to be established across the tubular channel.

22. A method for producing a three-dimensional object comprising anisotropic material with one or more specific alignments, the method comprising:
causing an anisotropic material to enter a tubular channel of a three-dimensional print head;
heating the anisotropic material;
performing one or both of the following operations:
(a) applying one or more voltages to one or more electrodes positioned to at least partially surround a section of the tubular channel, or
(b) providing one or more currents to one or more coils positioned at, or at least partially surrounding, another section of the tubular channel, wherein an electric field produced by the one or more electrodes or a magnetic field produced by one or more coils imparts a particular alignment to the anisotropic material; and
extruding the anisotropic material having the particular alignment from a nozzle of the print head.

23. The method of claim 22, further comprising modifying one or both of: (a) the one or more voltages or (b) the one or more currents to impart a different alignment to the anisotropic material.

24. The method of claim 23, wherein the modifying is carried out to produce a different alignment for each layer of the three-dimensional object.

25. The method of claim 23, wherein the modifying is carried out to produce a first alignment for one part of a first layer of the three-dimensional object that is different from a second alignment for another part of the first layer of the three-dimensional object.

26-36. (canceled)
